(19) United States
(12) Patent Application Publication
(10) Pub. No.: US 2016/0362287 A1
(43) Pub. Date: Dec. 15, 2016

(54) TOP-LOADING BOTTLED WATER DISPENSERS WITH HOT WATER SANITIZING FEATURES

(71) Applicants: George Yui, Toronto (CA); Andrei Yui, Toronto (CA)

(72) Inventors: George Yui, Toronto (CA); Andrei Yui, Toronto (CA)

(21) Appl. No.: 14/857,547

(22) Filed: Sep. 17, 2015

Related U.S. Application Data
(60) Provisional application No. 62/173,310, filed on Jun. 9, 2015.

(51) Int. Cl. B67D 1/07; B67D 1/08; B67D 1/10; B67D 1/00

(52) U.S. Cl. CPC B67D 1/07; B67D 1/0009; B67D 1/0888; B67D 1/10; B67D 1/0895; B67D 1/0859; B67D 2001/075

(57) ABSTRACT

Top-loading bottled water dispensers are disclosed that include hot water sanitizing capabilities (and, optionally, ozone sanitizing features). The dispensers include a cold tank equipped with an evaporator that is configured to chill the water in the cold tank. The dispensers further include a hot tank that is fluidly coupled to the cold tank through one or more tubes, with the hot tank being attached to a heating element that is configured to heat the water in the hot tank. In addition, the dispensers include an electronic control board that is configured to heat the volume of water contained in the cold tank above a defined threshold temperature and for a defined period of time that is effective to sanitize the internal surfaces of the cold tank. The dispensers further include a floating disk valve that is configured to prevent entry of hot water into the water bottle.

### CROSS-REFERENCE TO RELATED APPLICATIONS

This application is a non-provisional of, and claims priority to, U.S. provisional patent application Ser. No. 62/173,310, filed Jun. 9, 2015.

### FIELD OF THE INVENTION

The field of the present invention relates to top-loading bottled water dispensers that include hot water sanitizing capabilities.

### BACKGROUND OF THE INVENTION

Bottled water dispensers are routinely used in homes and businesses as a source of clean and refreshing drinking water. Such dispensers may exhibit various forms, with some dispensers being configured to dispense both chilled and hot water. Unfortunately, the portions of such dispensers that hold and dispense chilled water create a suitable environment for bacterial growth and contamination. Several methods have evolved over the years to combat bacterial growth in bottled water dispensers, which range from manual cleanings to the use of UV lamps and ozone. Unfortunately, certain known methods suffer from a number of drawbacks, such as being inefficient, labor intensive, expensive to implement, or they can present their own health risks.

In view of the foregoing, there is a continuing need for new and improved bottled water dispensers that provide an effective means for sanitizing the interior portions of the dispensers, and particularly those areas and surfaces that are most prone to bacterial growth and contamination. As the following will demonstrate, such needs and demands in the marketplace (along with others) are provided by the inventions described herein.

### SUMMARY OF THE INVENTION

According to certain aspects of the present invention, top-loading bottled water dispensers are provided that include hot water sanitizing capabilities. More specifically, the bottled water dispensers of the present invention include a means for applying sanitizing hot water to the internal surfaces of the dispensers that are most prone to bacterial contamination. The dispensers of the present invention include a cabinet, which is configured to receive a water bottle in an inverted position, which holds a defined volume of water and may be easily replaced when the water has been depleted.

The invention provides that the cabinet includes a receptacle on a top surface of the cabinet, which is configured to receive the water bottle in an inverted position, such that the water bottle is fluidly coupled to a cold tank within the cabinet. The dispensers further include a probe that is attached to a floating disk valve. The probe is configured to be inserted into the opening of the neck portion of the water bottle—and the probe includes an aperture through which water may flow (exit the bottle) and enter the cold tank. According to certain aspects of the invention, the floating disk valve is configured to be positioned and reside outside of the neck portion of the water bottle; the floating disc valve is configured to float on a surface of water in the cold tank and to prevent hot water (which may be present in the cold tank during a sanitization cycle) from entering the water bottle; and the floating disc valve comprises an aperture in a center area of the valve that is configured to balance the air pressure between the water bottle and the cold tank.

The dispensers further include an evaporator that is attached to or positioned within the cold tank, which is configured to chill the water contained in the cold tank. In addition, the dispensers include a hot tank that is fluidly coupled to the cold tank through one or more tubes, with the hot tank being equipped with a heating element that is configured to heat the water in the hot tank. Still further, the dispensers include a first external faucet that is fluidly coupled to the cold tank and a second external faucet that is fluidly coupled to the hot tank. In addition, the dispensers include an electronic control board that is configured to cause a volume of water contained in the cold tank to be heated above a defined threshold temperature and for a defined period of time that is effective to sanitize the internal surfaces of the cold tank.

According to certain aspects of the invention, the electronic control board is configured to heat the volume of water contained in the cold tank by opening a valve located within a dedicated tube that fluidly couples the cold tank and hot tank and causing hot water to flow from the hot tank and into the cold tank through the dedicated tube. In other embodiments, the electronic control board is configured to heat the volume of water contained in the cold tank by activating a heating element located within the cold tank. Still further, in certain embodiments, the electronic control board is configured to heat the volume of water contained in the cold tank by activating a circulating pump to force water from the hot tank and into the cold tank through a dedicated tube. The invention provides that the electronic control board is programmed to heat the volume of water contained in the cold tank to execute a sanitization procedure during a defined period of time of a specified day or set of days—or upon the instruction of a user of the water dispenser.

According to further aspects of the invention, the first external faucet that is fluidly coupled to the cold tank is prevented from dispensing water during a sanitization procedure. For example, the first external faucet may be operably coupled to a solenoid valve that, when instructed by the electronic control board, is configured to close and prevent the first external faucet from being operated by a user to dispense water from the cold tank during a sanitization procedure. In addition, in certain preferred embodiments, the electronic control board is programmed to deactivate a compressor that is coupled to the evaporator during a sanitization procedure.

According to yet further aspects of the invention, the water dispensers may further comprise an ozone generator that is configured to provide ozone gas to the cold tank via an ozone tube that fluidly couples the ozone generator to the cold tank. The invention provides that the ozone tube may terminate above the surface of water in the cold tank or, alternatively, the ozone tube may terminate below the surface of water in the cold tank. When the ozone tube terminates below the surface of water in the cold tank, the ozone tube will preferably include a diffuser at its terminal end, below the surface of water in the cold tank.

The above-mentioned and additional features of the present invention are further illustrated in the Detailed Description contained herein.

### BRIEF DESCRIPTION OF THE FIGURES

FIG. 1 is a perspective external view of the bottled water dispensers of the present invention.

FIG. 2 is an internal diagram of certain embodiments of the bottled water dispensers of the present invention.

FIG. 3 is an internal diagram of another embodiment of the bottled water dispensers of the present invention, which includes a solenoid water valve that is configured to deactivate the external faucets during a hot water sanitization procedure.

FIG. 4 is an internal diagram of another embodiment of the bottled water dispensers of the present invention, which includes a solenoid plunger valve that is configured to deactivate the cold water external faucet during a hot water sanitization procedure.

FIG. 5 is an internal diagram of another embodiment of the bottled water dispensers of the present invention, which includes a solenoid water valve that is configured to deactivate the external faucets during a hot water sanitization procedure and a recirculating pump that forces water from the hot water tank and into the cold water tank during a hot water sanitization procedure.

FIG. 6 is an internal diagram of another embodiment of the bottled water dispensers of the present invention, which includes a heating element attached to the floor of the cold water tank and a solenoid plunger valve that is configured to deactivate the cold water external faucet during a hot water sanitization procedure.

FIG. 7 is an internal diagram of another embodiment of the bottled water dispensers of the present invention, which includes a heating element attached to the floor of the cold water tank and a solenoid water valve that is configured to deactivate the external faucets during a hot water sanitization procedure.

FIG. 8 is an internal diagram of another embodiment of the bottled water dispensers of the present invention, which includes a cooling evaporator located within the cold water tank and a solenoid plunger valve that is configured to deactivate the cold water external faucet during a hot water sanitization procedure.

FIG. 9 is an internal diagram of another embodiment of the bottled water dispensers of the present invention, which includes a cooling evaporator located within the cold water tank and a solenoid water valve that is configured to deactivate the external faucets during a hot water sanitization procedure.

FIG. 10 is an internal diagram of another embodiment of the bottled water dispensers of the present invention, which includes a cooling evaporator located within the cold water tank, a solenoid plunger valve that is configured to deactivate the cold water external faucet during a hot water sanitization procedure, and a recirculating pump that forces water from the hot water tank and into the cold water tank during a hot water sanitization procedure.

FIG. 11 is an internal diagram of another embodiment of the bottled water dispensers of the present invention, which includes a cooling evaporator located within the cold water tank, a solenoid water valve that is configured to deactivate the external faucets during a hot water sanitization procedure, and a recirculating pump that forces water from the hot water tank and into the cold water tank during a hot water sanitization procedure.

FIG. 12 is an internal diagram of another embodiment of the bottled water dispensers of the present invention, which includes a cooling evaporator and a heating element located within the cold water tank, and a solenoid plunger valve that is configured to deactivate the cold water external faucet during a hot water sanitization procedure.

FIG. 13 is an internal diagram of another embodiment of the bottled water dispensers of the present invention, which includes a cooling evaporator and a heating element located within the cold water tank, and a solenoid water valve that is configured to deactivate the external faucets during a hot water sanitization procedure.

FIG. 14 is a bottom side (A) and top side (B) diagram of the floating disc valve described herein.

FIG. 15 is a diagram of the water bottle probe described herein.

FIG. 16 is a disassembled diagram of a solenoid valve that may be used in the dispensers of the present invention.

FIG. 17 is another disassembled diagram of another solenoid valve that may be used in the dispensers of the present invention (which has a water-in and water-out configuration that is different than the configuration shown in FIG. 16).

FIG. 18 is a diagram of an energizing coil that may be used in the solenoid valves of FIGS. 16 and 17.

FIG. 19 is a diagram of a pressure valve that may be included in the cold water tank or bottle receptacle of the water dispensers described herein.

FIG. 20 is a diagram of a water dispenser that includes the pressure valve of FIG. 19.

FIG. 21 is a diagram of the calcium filter described herein.

FIG. 22 is a diagram of a water dispenser of the present invention, which includes the calcium filter of FIG. 21.

FIG. 23 is a diagram of a water dispenser of the present invention, which shows the location of an activated carbon filter to sequester ozone gas.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

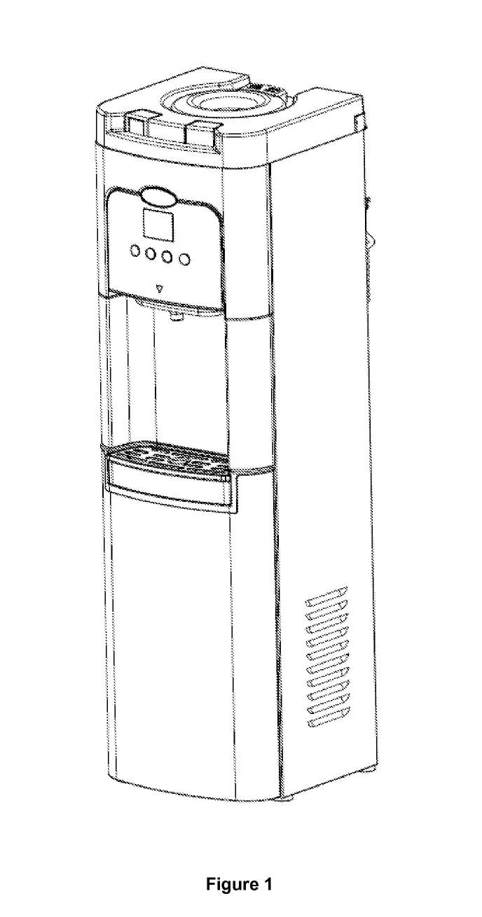

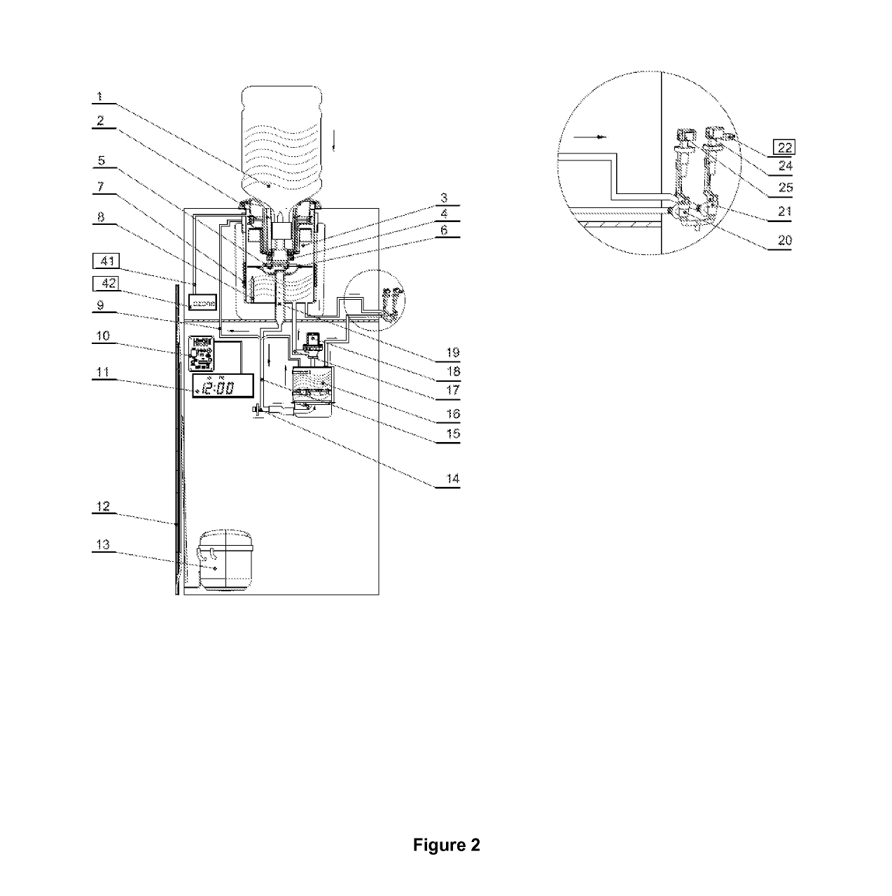

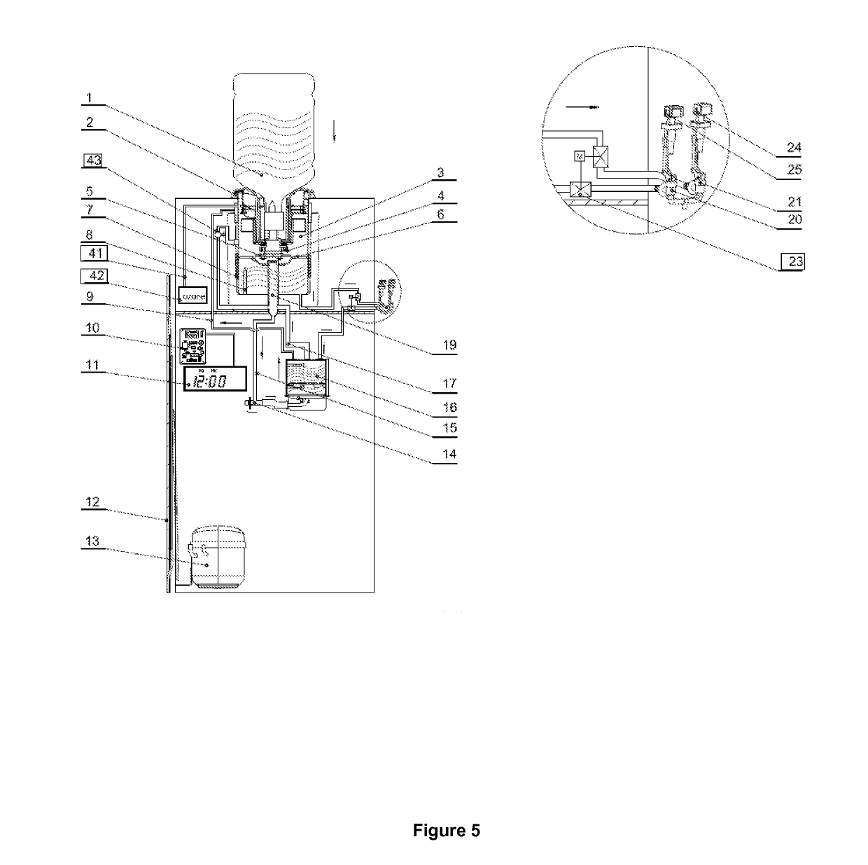

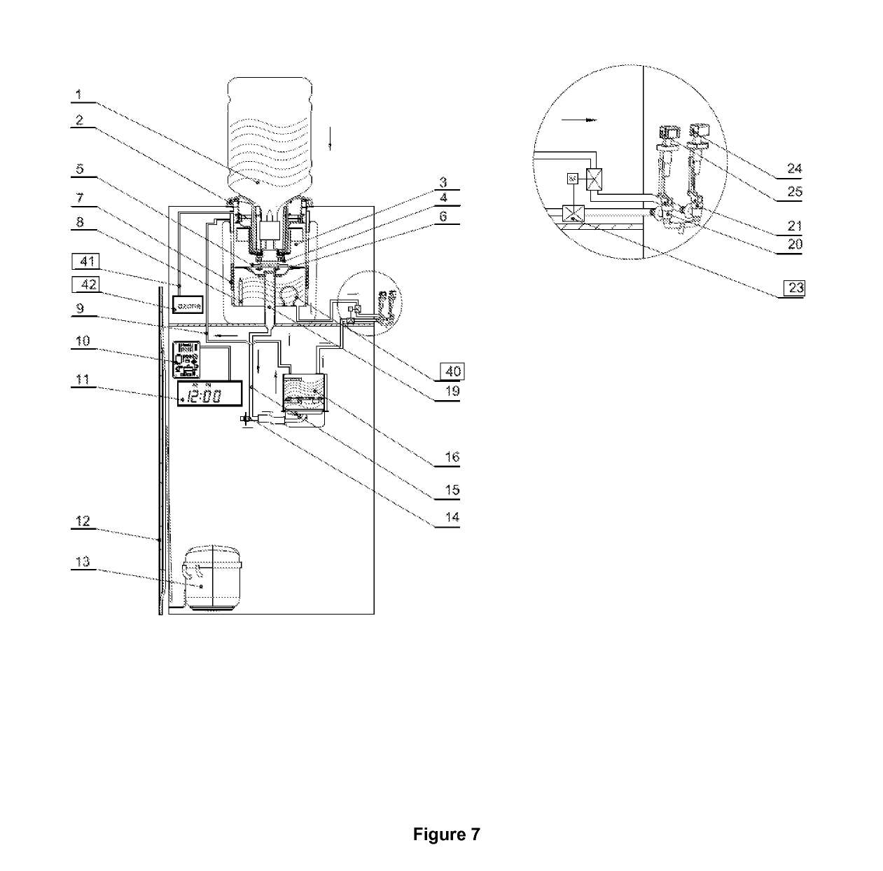

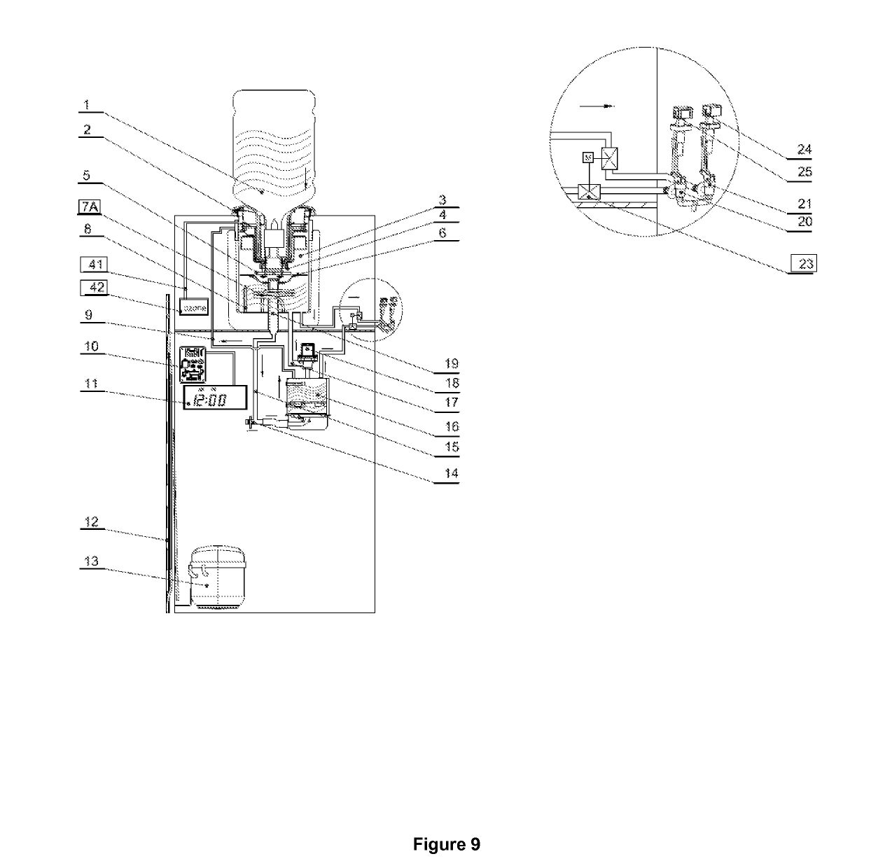

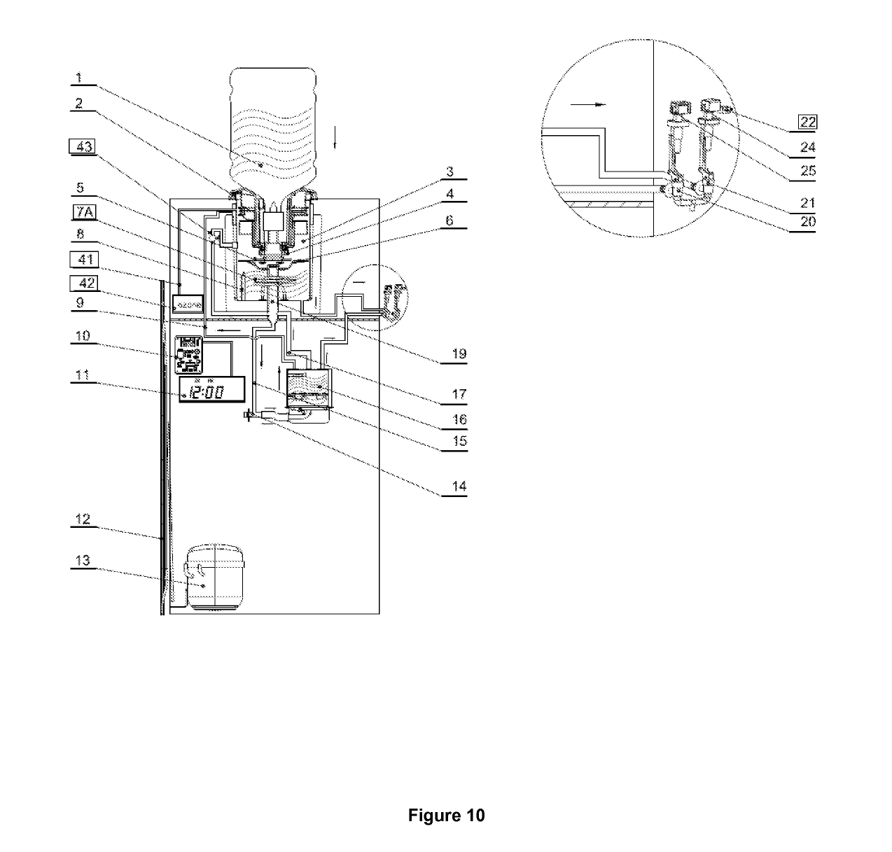

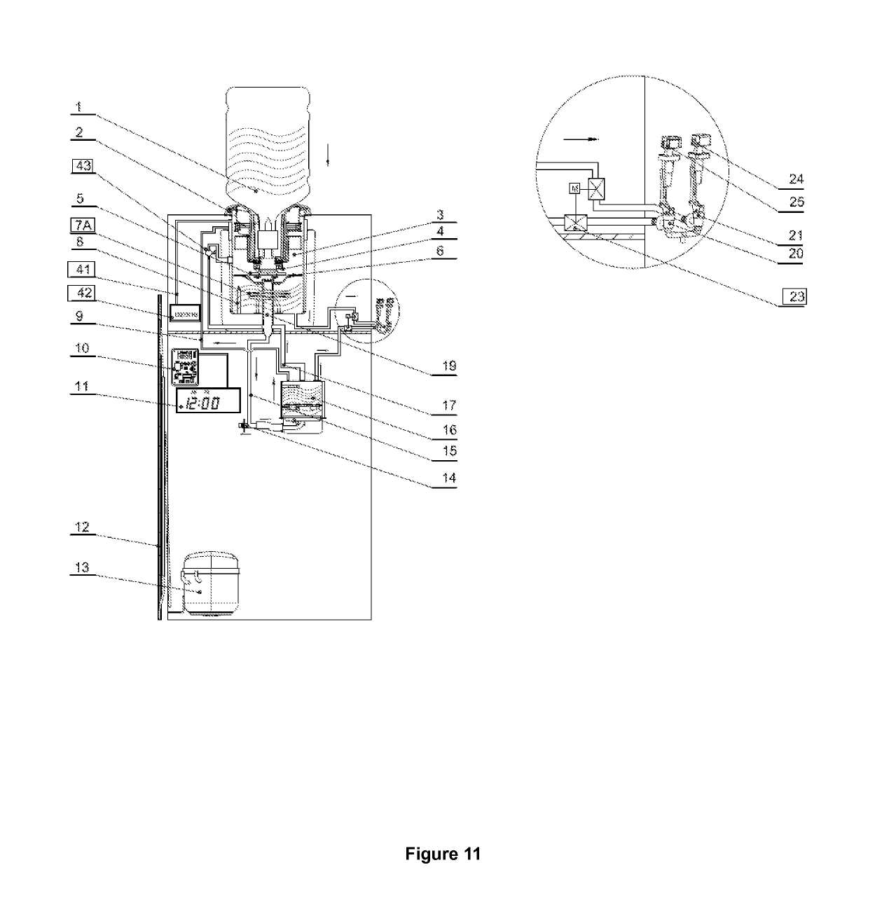

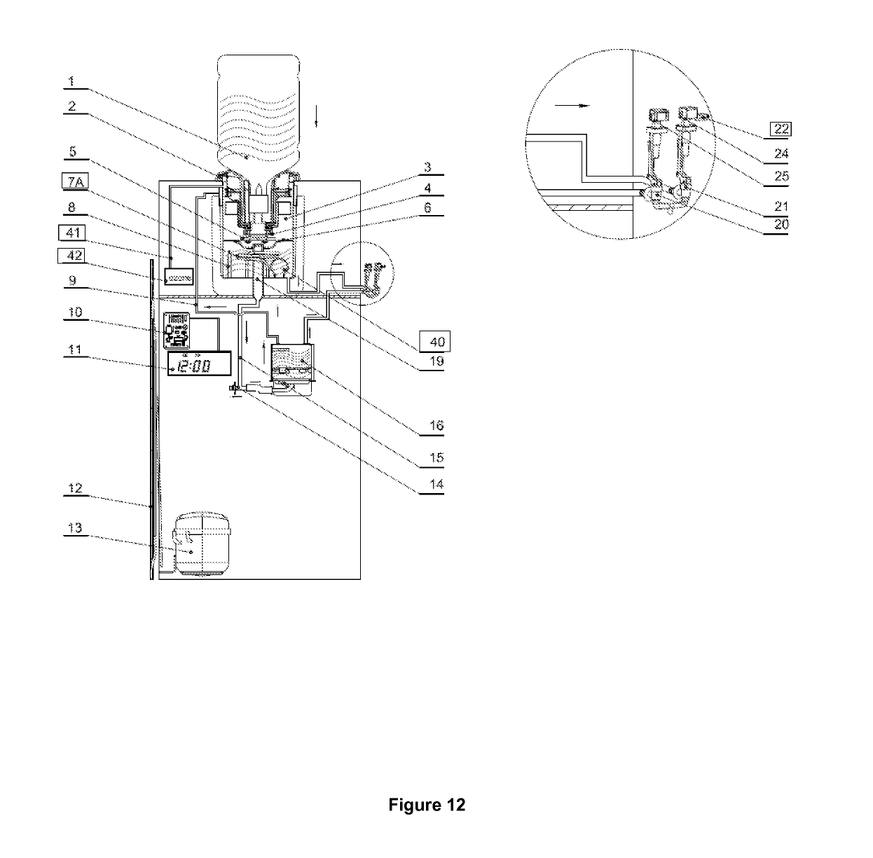

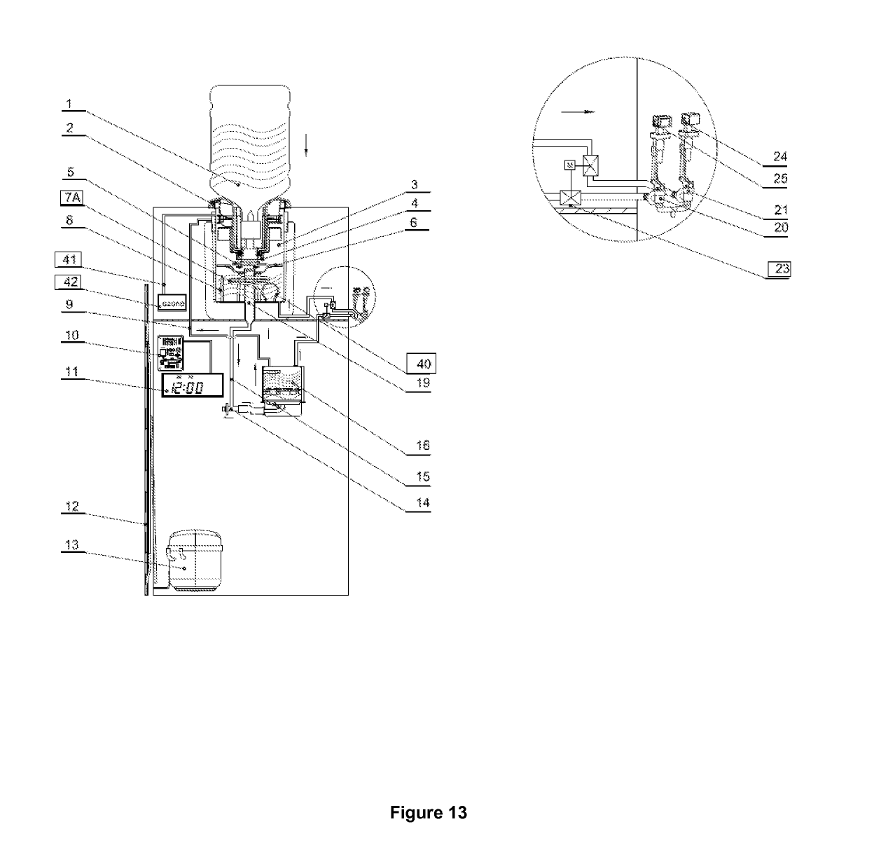

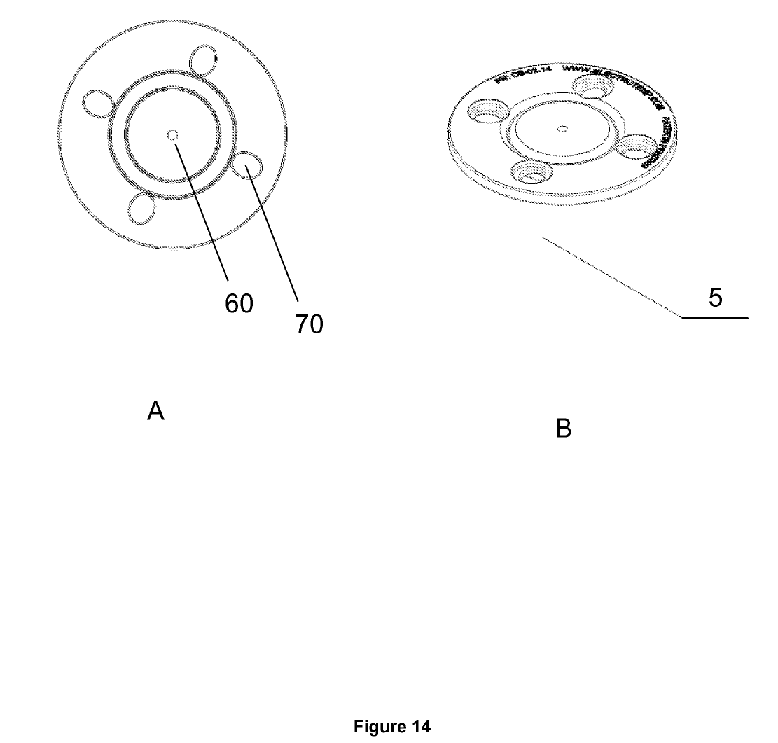

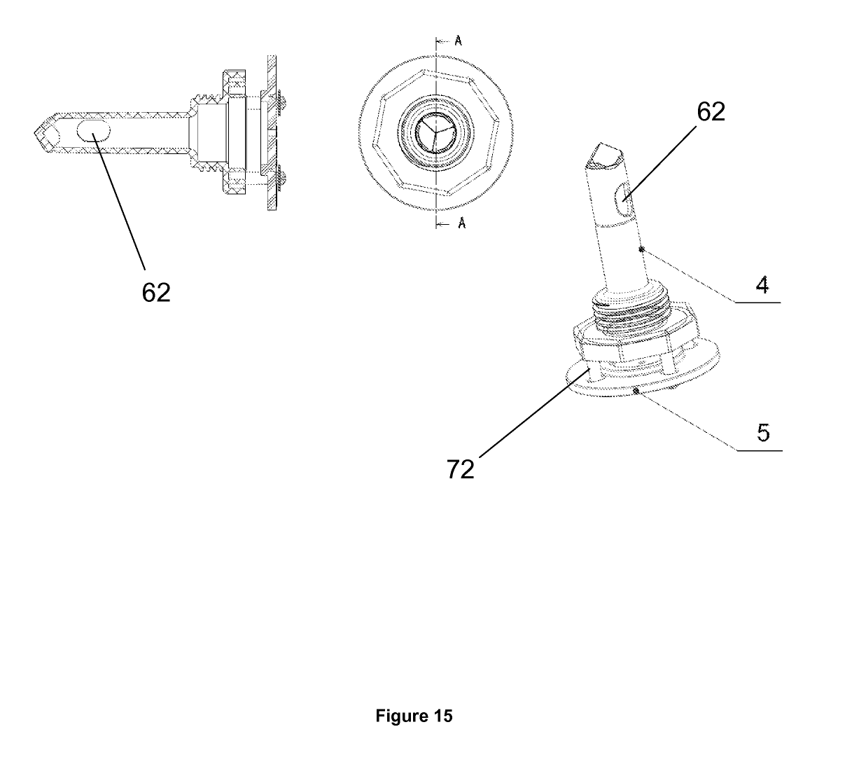

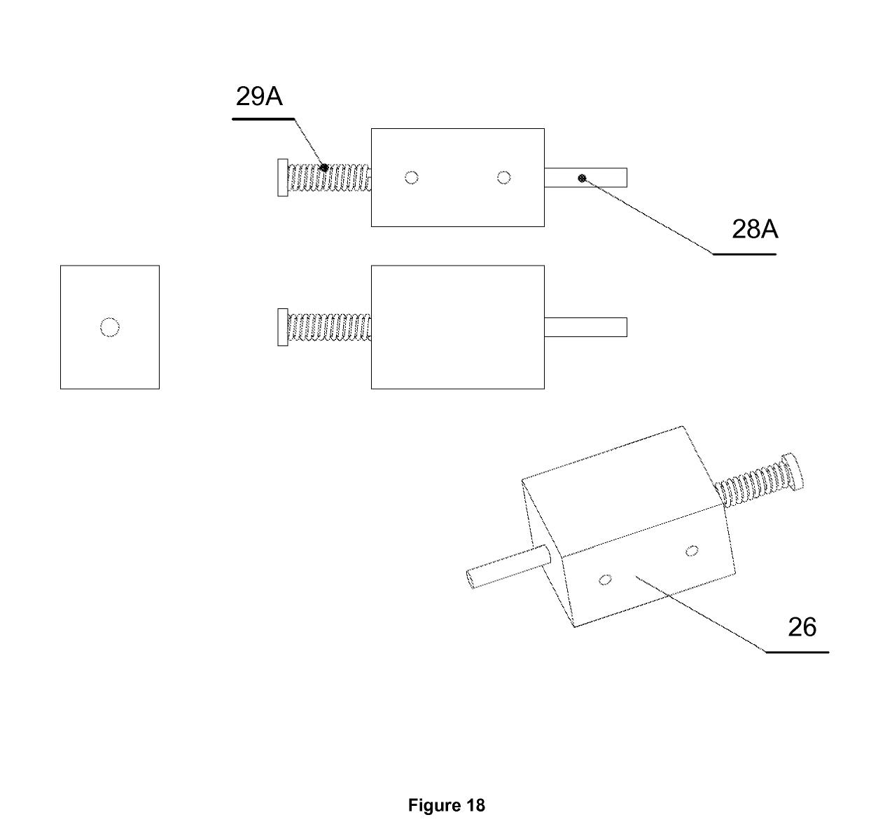

Referring now to FIGS. 1-20, the bottled water dispensers of the present invention generally include a cabinet that is configured to receive a bottle of water (1) in an inverted position (e.g., a bottle holding about 5-gallons of water), such that the “neck” of the bottle (1) is attached to a receptacle (2) located in a top area of the cabinet. The “neck” of the bottle (1) and receptacle (2) are fluidly coupled to a cold water tank (3). As illustrated in FIGS. 2 and 15, the dispenser of the present invention includes a probe (4) and a connected floating disk valve (5). The probe (4) includes a hole (62) through which water may flow (via gravity force) from the bottle of water (1), past the floating disk valve (5), and into the cold water tank (3). The floating disk valve (5) is configured to prevent hot water (which may be present in the cold water tank (3) during a sanitization cycle, as described herein) from entering the bottle of water (1). Referring to FIGS. 14 and 15, the invention provides that the floating disk valve (5) will include a hole (60), e.g., a hole about ⅛ inch in diameter positioned in the center of the floating disk valve (5), and four apertures (70) that are each configured to receive a guide pin (72). This arrangement allows the floating disk valve (5) to travel up-and-down the guide pins (72), to open or close the aperture (62) in the probe (4)—and to prevent hot water from entering the bottle of water (1). The invention provides that the four apertures (70) are, preferably, oval-shaped to prevent the floating disk valve (5) from jamming or becoming stuck on the guide pins (72). The floating disk valve (5) is preferably comprised of polypropylene and will have a specific gravity of about 0.97 (slightly less than the specific gravity of water). The aperture (62) in the probe (4) is configured to permit the flow of water and air, and further serves to balance the pressure in the bottle of water (1) and cold water tank (3).

More particularly, the invention provides that as the water level in the cold water tank (3) increases, the floating disk valve (5)—which floats on the surface of the water in the cold water tank (3)—is pushed upwards towards the “neck” of the bottle (1), eventually to a point that it covers the aperture (62) in the probe (4). This way, the floating disk valve (5) is able to prevent the flow of hot water from the cold water tank (3), which may be present during a sanitization cycle, into the bottle of water (1). The invention provides that hole (60) of the floating disk valve (5) is configured to balance the air pressure between the bottle (1) and the cold water tank (3). More particularly, the hole (60) is configured to prevent an air lock between the bottle (1) and the cold water tank (3), which would otherwise prevent the flow of water from the bottle (1) to the cold water tank (3), as described herein.

In addition, the cold water tank (3) may comprise a baffle (6), which separates the cold water tank (3) into a top area, which directly receives water from the bottle (1), and a lower area from which chilled water may be dispensed by a user. In such embodiments, the baffle (6) will help separate new room-temperature water that enters the cold water tank (3) from the chilled water located in the lower area of the cold water tank (3), such that the two bodies of water are allowed to mix gradually without quickly and substantially affecting the temperature of the chilled water.

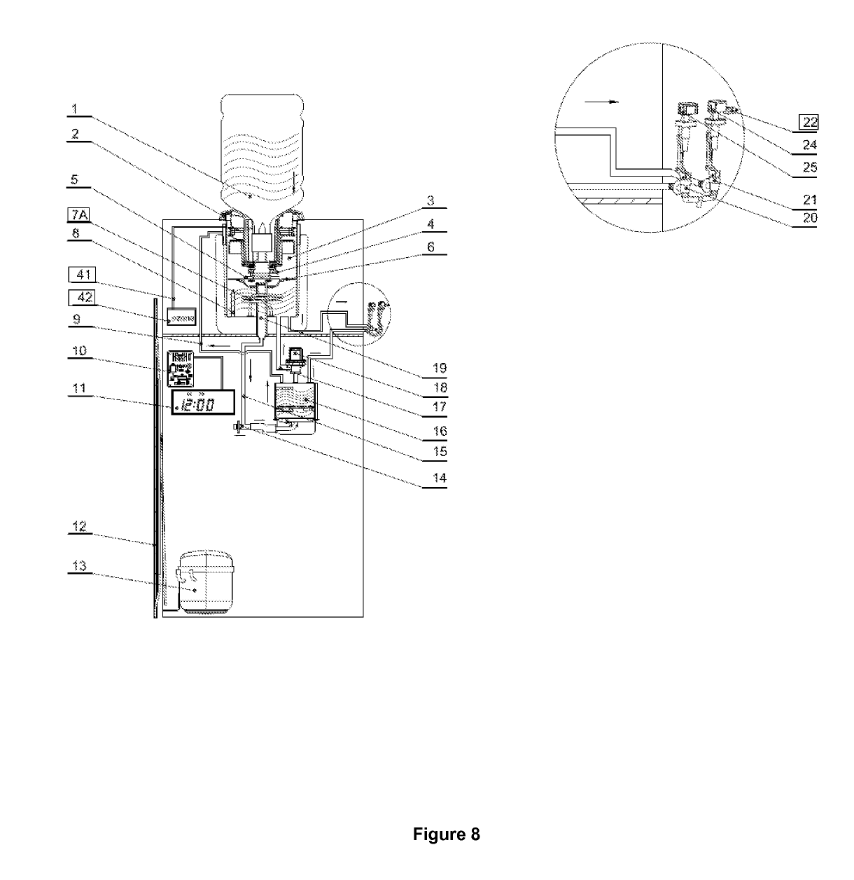

The invention further provides that the cold water tank (3) is equipped with an external evaporator (7), which wraps around the exterior of the cold water tank (3) and, together with an operably connected compressor (13) and refrigeration condenser (12), is configured to chill the water contained within the cold water tank (3). Referring to FIG. 8, in certain embodiments, the cold water tank (3) may include an internal evaporator (7A), which is configured to chill the water contained within the cold water tank (3). The cold water tank (3) preferably includes a temperature sensor (8) located within the interior of the cold water tank (3) (but may also reside outside of the cold water tank (3)), which is configured to detect and continuously monitor the temperature of the water contained in the cold water tank (3), which information is also reported to the electronic control board (10) of the dispenser.

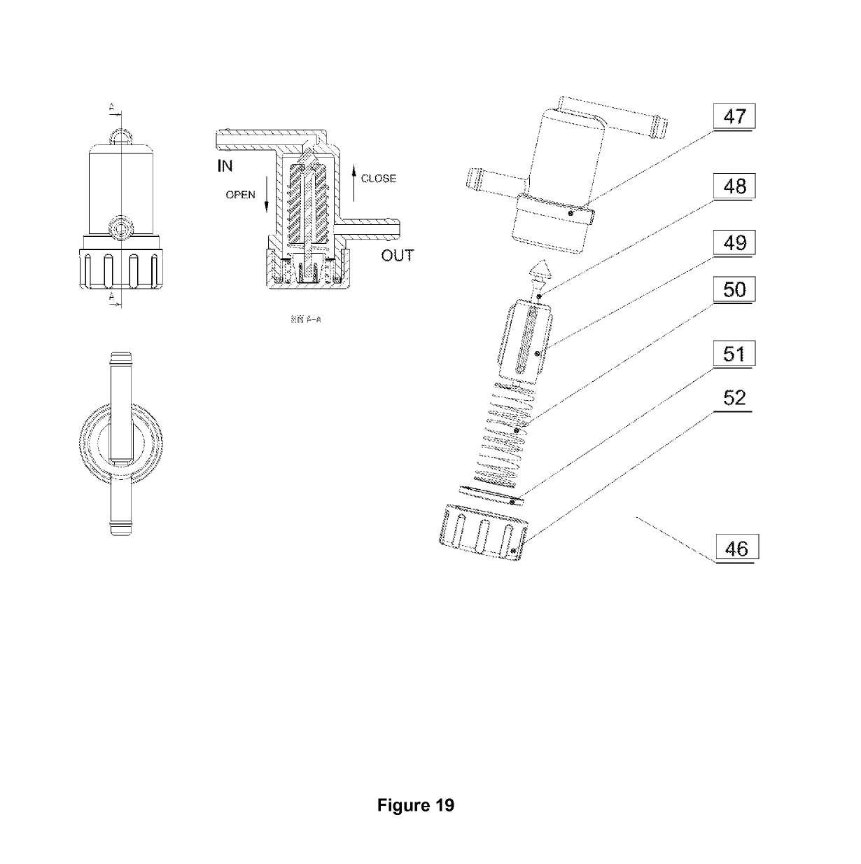

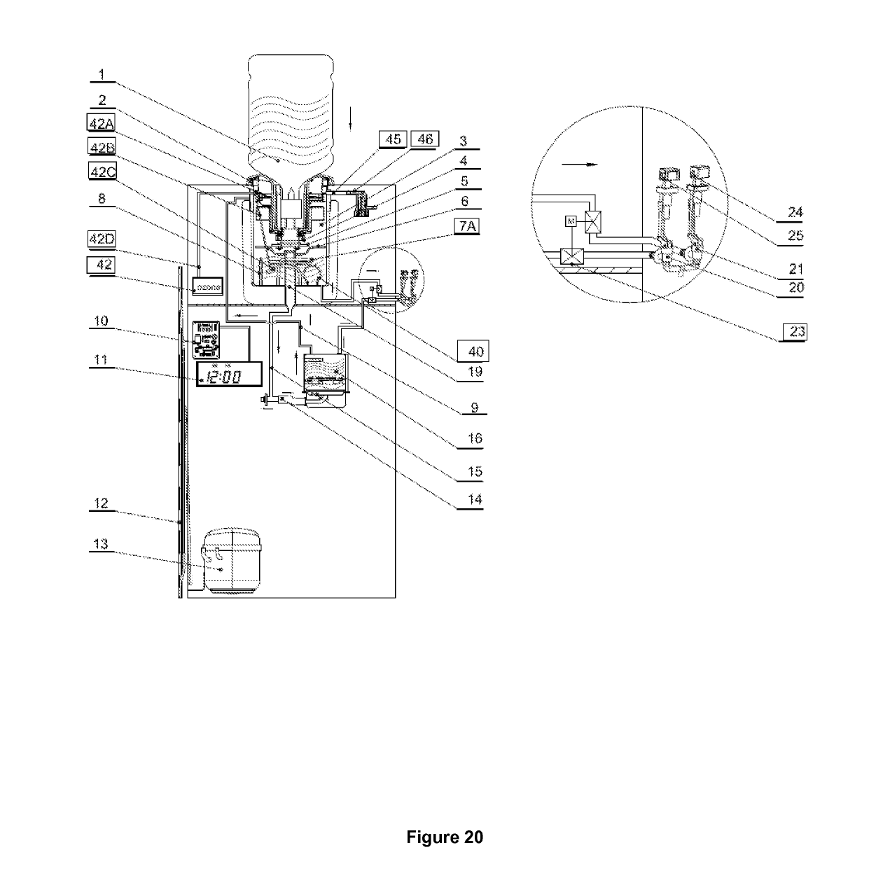

In certain additional embodiments, and referring to FIGS. 19 and 20, the cold water tank (3) or the receptacle (2) located in a top area of the cabinet may include a pressure valve (46). The invention provides that when the water temperature in the cold water tank (3) increases significantly during a hot water sanitization procedure (as described below), pressure can build within the cold water tank (3) that must be relieved. Such pressure may be allowed to exit the cold water tank (3) through the pressure valve (46). In such embodiments, a tube (45) will connect the pressure valve (46) and bottle receptacle (2). Referring to FIG. 19, the pressure valve (46) will preferably comprise a top cover (47), a silica gel valve (48), a base unit (49), a spring (50), a seal ring (51), and a bottom (nut) cover (52). The invention provides that the pressure valve (46) is configured to balance the need to be sufficiently resistant and strong to maintain a desirable vacuum pressure in the water bottle (1), while being sufficiently weak to permit excessive pressure/air to escape from the cold water tank (3). The invention provides that the spring (50) is configured to impart the desirable level of pressure within the pressure valve (46), which may be adjusted (as necessary) by moving the bottom (nut) cover (52) up or down to compress or decompress the spring (50) (the bottom (nut) cover (52) is preferably attached to the pressure valve (46) via a threaded/screw-like engagement). In addition to the pressure valve (46) shown and described herein, the invention provides that other pressure valves may be employed for this purpose, such as an electrically operated solenoid valve.

The bottled water dispensers of the present invention include a tube (15), a drain fitting (14), and rigid tube (19), which are configured to funnel (and back-fill) water from the cold water tank (3) to a hot water tank (16), which is located below the cold water tank (3). The rigid tube (19) is configured to hold the baffle (6) in place, and it fluidly couples the cold water tank (3) to tube (15). The invention provides that the hot water tank (16) is equipped with an electrical heater, which is configured to heat the water contained within the hot water tank (16). The invention provides that the electrical heater may be mounted to the bottom or within the hot water tank (16)—alternatively, external band heaters wrapped around the hot water tank (16) or a heating tube (through which water passes to heat the water) may be employed.

The invention provides that a tube (9) connects a top portion of the hot water tank (16) to the top portion of the cold water tank (3), which is configured to allow steam that is generated in the hot water tank (16) to exit and recirculate into the cold water tank (3). The invention further provides that the dispenser includes a tube (17), and a solenoid valve (18) positioned in-line with such tube (17), which are configured to deliver hot water (from the hot water tank (16)) back to the cold water tank (3) during a sanitization procedure, as described further below. Still further, the invention provides that a set of tubes fluidly couple the hot water tank (16) and the cold water tank (3) to a dedicated and mechanically-operated external hot water faucet (20) and cold water faucet (21), respectively. The hot water faucet (20) and cold water faucet (21) may be used to dispense water by manually pressing a corresponding faucet actuator (25)/(24). The invention provides that water is caused to exit the hot water tank (16) and cold water tank (3) through the faucets (20)/(21) by way of hydrostatic pressure.

During operation, when the water temperature rises above a defined threshold, which is reported to the electronic control board (10) by the temperature sensor (8) located within the cold water tank (3), the electronic control board (10) will instruct the compressor (13) to activate and begin chilling the water via the evaporator (7/7A). Once the water temperature dips below the defined threshold, the electronic control board (10) will instruct the compressor (13) to deactivate. The invention provides that the electronic control board (10) is preferably coupled to a visual display (11), which a user of the dispenser may view to ascertain the then current water temperatures (and, optionally, make adjustments to the desirable temperatures of the water included in the cold water tank (3) and hot water tank (16)).

The invention provides that water flows from the cold water tank (3) through tube (15) to the hot water tank (16) by way of gravity force. The electrical heater that is connected to, or positioned within, the hot water tank (16) is configured to heat the water contained within the hot water tank (16). The hot water tank (16) preferably includes its own temperature sensor, which is configured to monitor and report the temperature of the water to the electronic control board (10). As with the cold water tank (3), the electronic control board (10) will control the temperature of the water contained in the hot water tank (16) by instructing the heater to activate or deactivate, as necessary, to maintain the water temperature above a defined threshold (or within a defined range).

According to certain preferred embodiments, the water dispensers of the present invention are configured to sanitize the interior portions of the dispensers, and particularly those areas and surfaces that are most prone to bacterial growth and contamination, using hot water. As used herein, the term “sanitize” means to kill a certain portion of bacteria, e.g., substantially all of the bacteria, which may be located on an internal surface of the dispenser, such as the internal surfaces of the cold water tank (3). The invention provides that the protocol followed to perform the sanitization procedure may be controlled by a user through the external display (11), which will be saved and implemented by the electronic control board (10). The protocol may specify the frequency, duration, and timing of each sanitization procedure, as well as the temperature settings employed for the procedure.

At the commencement of a sanitization cycle, the electronic control board (19) will instruct the compressor (13) to deactivate (while the electrical heater of the hot water tank (16) is instructed to activate). Next, solenoid valve (18) is instructed to convert to an open position, such that cold water in the cold water tank (3) and hot water in the hot water tank (16) are allowed to mix. The invention provides that the temperature sensor (8) in the cold water tank (3) will monitor and report the increase in temperature to the electronic control board (10), which will continue the sanitization cycle until the water temperature of the cold water tank (3) reaches and stays above a defined threshold for a defined period of time.

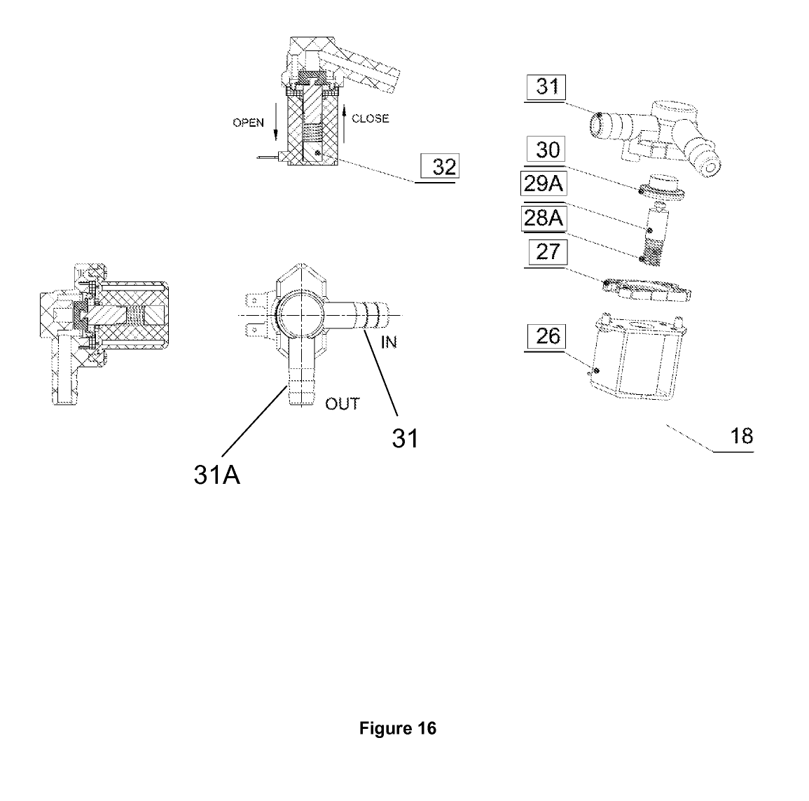

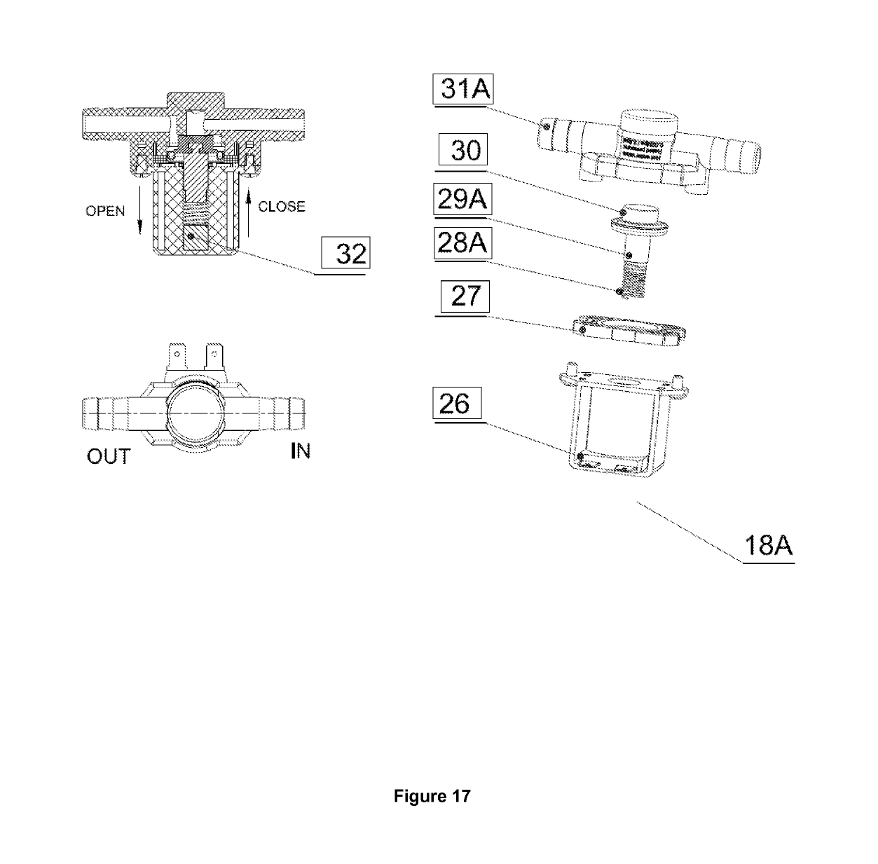

FIGS. 16 and 17 provide two non-limiting examples of the solenoid valve (18) that may be used to fluidly connect the cold water tank (3) and hot water tank (16) through tube (17). The solenoid valve (18) generally includes a body portion (26), a cover (27), a spring (28A), a plunger (29A), a seal (30), a water-in port (31), a water-out port (31A), and a spacer (32). The invention provides that when the solenoid valve (18) is activated (energized) by the electronic control board (19), the spring plunger (29A) moves downward to open the seal (30) and to permit the flow of hot water from the hot water tank (16) to the cold water tank (3) during a sanitization protocol. Conversely, when the solenoid valve (18) is deactivated by the electronic control board (19), the spring plunger (29A) moves upward to close the seal (30) and to prevent the flow of hot water from the hot water tank (16) to the cold water tank (3).

At the conclusion of the sanitization cycle, the electronic control board (10) will instruct solenoid valve (18) to convert to a closed position, and compressor (13) will be instructed to activate to begin chilling the water contained in the cold water tank (3). As such, solenoid valve (18) is configured to open and close to allow for direct exchange of water (and convection exchange) between the cold water tank (3) and hot water tank (16) through tube (17). The invention provides that, as part of the programmed sanitization cycle, the electronic control board (10) may instruct the compressor (13) to activate (and deactivate) intermittently, so as to avoid overloading the compressor (13) when it begins to chill the water in the cold water tank (3) following a sanitization cycle. In addition, the programmed sanitization cycle may also increase the frequency of compressor (13) activations as the water in the cold water tank (3) approaches the defined lower threshold, so as the expedite the chilling of the water once the temperature falls below the hot/sanitizing temperatures.

In certain preferred embodiments, during a sanitization cycle, the water temperature of the water in the cold water tank (3) will reach between 70-degrees Celsius and 85-degrees Celsius, and will maintain such temperature for between 1 to 40 minutes. The parameters of a sanitization cycle may be tailored to the size of the water tanks (3), (16), compressor (13), and the heater of the hot water tank (16). In certain embodiments, the total sanitization cycle may take about 3 to 4 hours, which includes the sanitization step of heating the water in the cold water tank (3) and subsequently chilling the water contained therein. As such, the electronic control board (10) may be pre-programmed, or programmed through the display (11), to execute a sanitization cycle during periods of non-use, such as around 2:00 a.m. (such that the cycle should be completed by the morning hours). In addition, the water dispenser may include a manually-operated control, e.g., within or in proximity of the display (11), which can be used to instruct the dispenser to perform the sanitization procedures described herein. For example, the manually-operated control may comprise a mechanical and/or electrical switch, which instructs the dispenser and electronic control board (10) to immediately execute the sanitization procedures described herein.

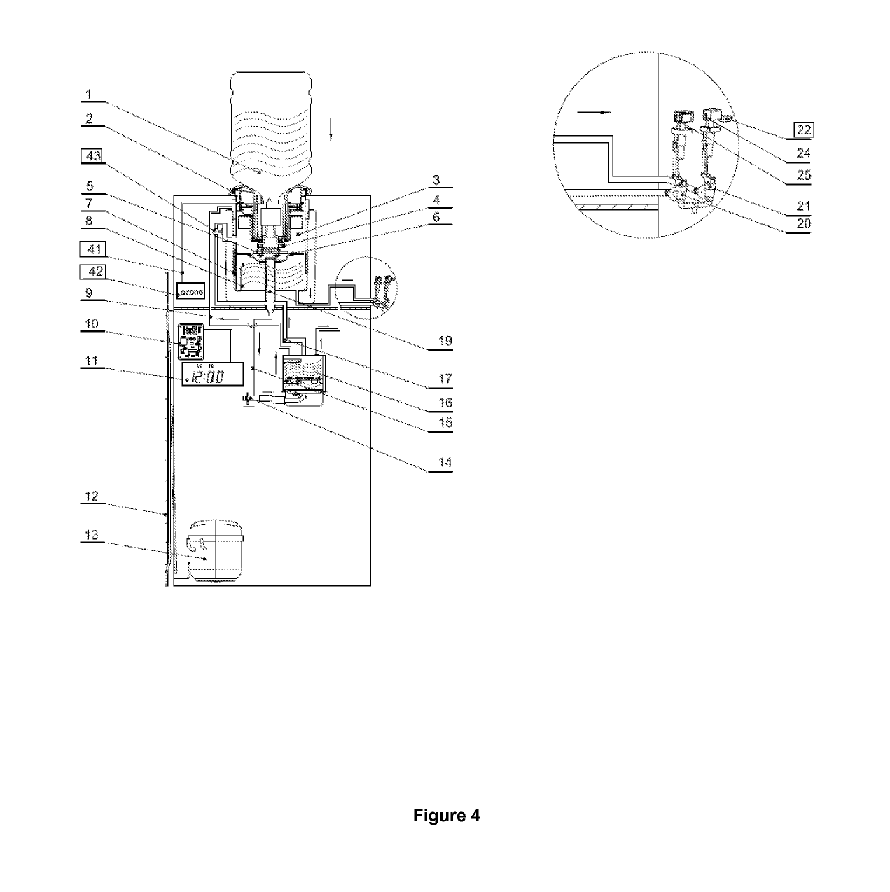

According to yet further embodiments and referring to FIG. 4, the bottled water dispensers of the present invention may include a recirculating water pump (43) that is configured and operated to force cold water in the cold water tank (3) to mix with the hot water of the hot water tank (16). In other words, in such embodiments, the pump (43) provides a force that is imparted (at the instruction of the electronic control board (10) during a sanitization cycle) to force water to travel from one tank (the hot water tank (16)) to another (the cold water tank (3)) via tube (17) and solenoid valve (18), instead of such mixing occurring by way of convection forces.

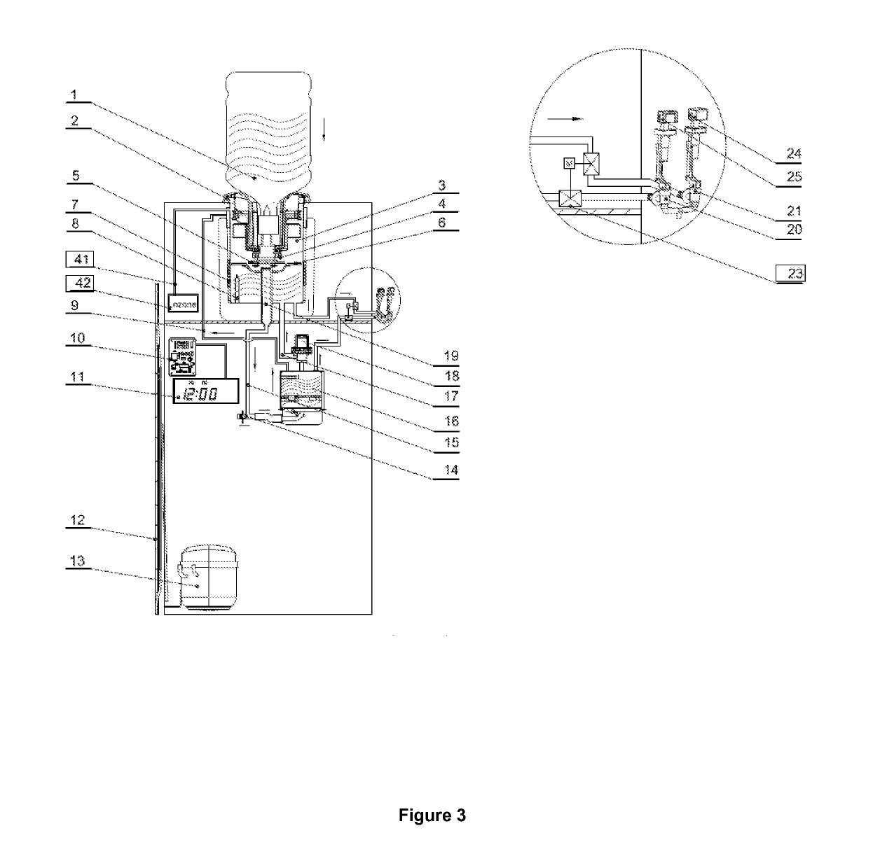

According to certain embodiments, the external faucets (20)/(21) of the water dispenser may be equipped with certain safety features, which prevent a user from unknowingly dispensing sanitizing hot water from either water tank during a sanitization cycle. More specifically, each faucet (20)/(21) may be operably coupled to a solenoid valve (23) (FIG. 3) that, when instructed by the electronic control board (10), will close and prevent the faucets from being operated by a user to dispense water from the applicable tank during a sanitization cycle. Referring to FIG. 4, in other embodiments, the cold water faucet (21) may be coupled to a plunger valve (22) that may be activated (by the electronic control board (10)) to prevent the faucet (21) from being operated by a user to dispense water from the cold water tank (3) during a sanitization cycle. More particularly, the plunger valve (22) may engage the actuator (24) of the faucet (21) to mechanically prevent the faucet (24) from being operated by a user to dispense water from the cold water tank (3) during a sanitization cycle. For example, the actuator (24) may include a vertical arm that may receive the plunger valve (22), such that the vertical arm (and actuator (24)) are prevented from being depressed by a user, which would otherwise cause a connected arm to pivot about a joint and cause the faucet (21) to open and water to exit therefrom. Following a sanitization cycle, once the water in the cold water tank (3) has returned to room temperature or below, the electronic control board (10) will instruct the solenoid valve (23) or plunger valve (22) to disengage, so that hot and cold water may then be dispensed from the faucets as described herein.

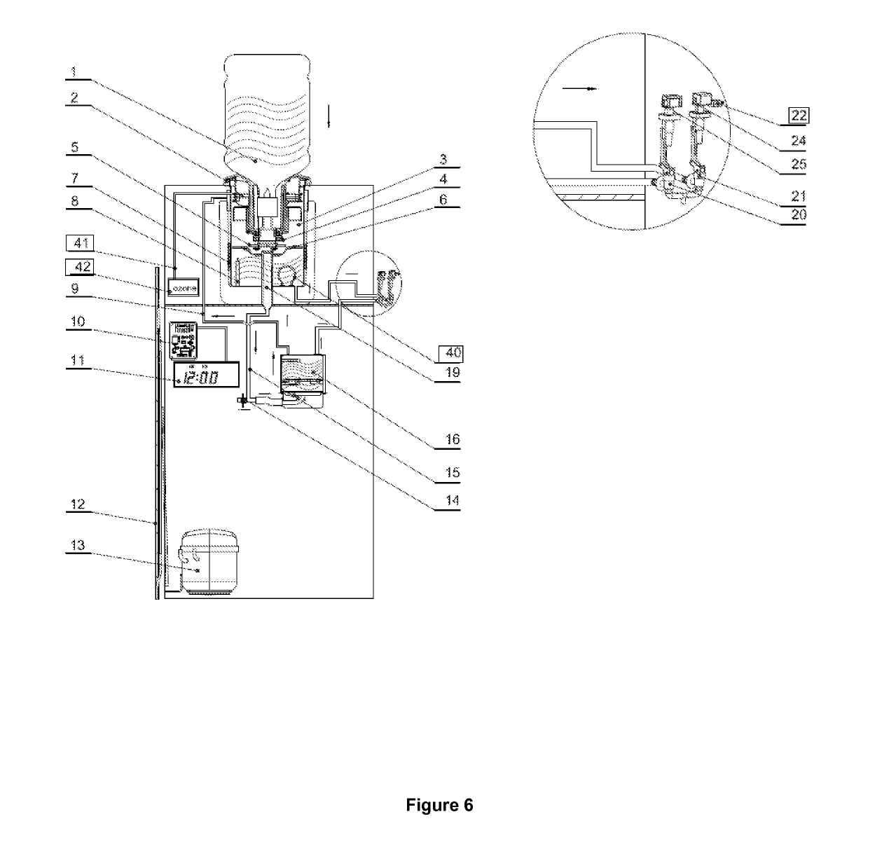

According to additional embodiments, and referring now to FIG. 6, the bottled water dispensers of the present invention may include a heating element (40) within the cold water tank (3). The heating element (40) may be attached to the floor or sides of the cold water tank (7). The heating element (40) may be activated by the electronic control board (10) during a sanitization cycle to directly heat the water contained in the cold water tank (3) to the programmed sanitization temperature, instead of using hot water from the hot water tank (16) for such purposes.

According to certain embodiments, the invention provides that the water dispensers may further comprise an ozone source/ozone generator (42). In such embodiments, the ozone generator (42) will provide a second means for sterilizing the interior areas of the cold water tank (3). This second means for sterilizing the interior areas of the cold water tank (3) can be important because, when water is dispensed from the dispenser, outside air is allowed to enter the bottle (1), which is sometimes referred to as “gargling” in the top of the bottle (1). This permits bacteria to enter the water and, eventually, the cold water tank (3)—where suitable conditions exist for bacteria survival and growth. Following a hot water sanitization procedure (as described above), the interior areas of the cold water tank (3) will be substantially free of bacteria, but may become contaminated once again when outside air is allowed to enter the dispenser. The use of ozone to periodically clean the cold water tank (3) will serve to further combat bacterial growth during the times between hot water sanitization procedures.

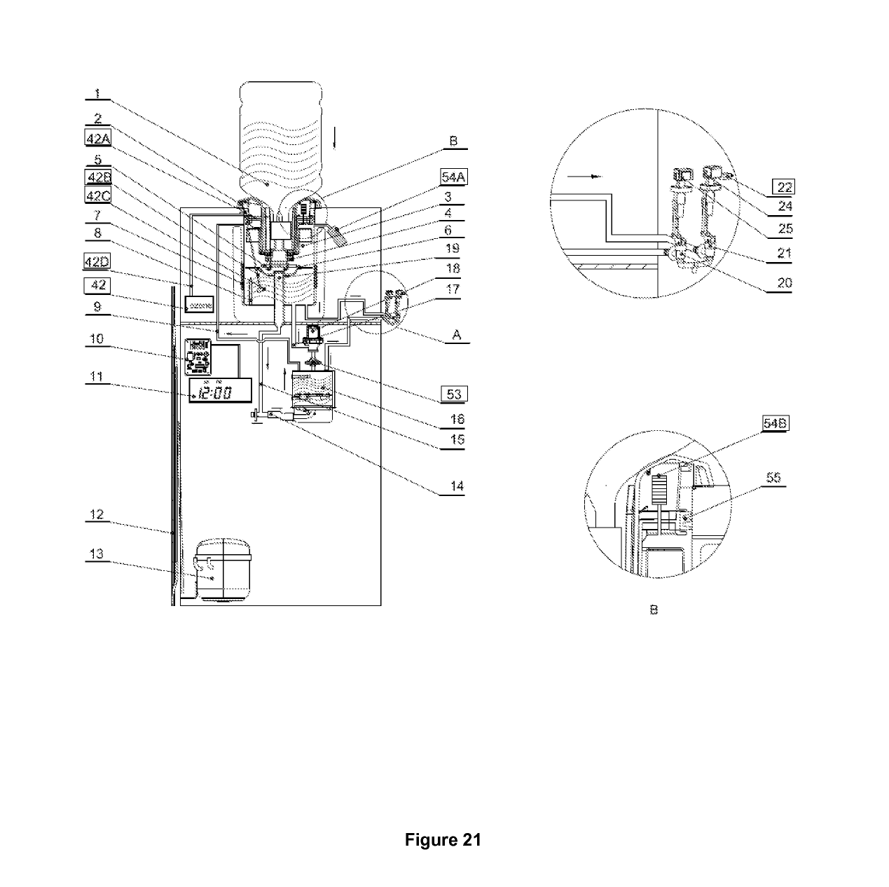

In these embodiments, the invention provides that the water dispensers will comprise a tube (41) that is configured to deliver and deposit ozone gas from the ozone generator (42) and to the water contained in the cold water tank (3). The invention provides that tube (41) may terminate above the water level of the cold water tank (3). Alternatively, tube (41) may terminate near the floor of the cold water tank (3) and submerged within the water, in which case the tube (41) will preferably include a diffuser through which the ozone gas will exit the tube (41) and enter the water of the cold water tank (3). The invention provides that the electronic control board (10) is configured to control the time(s) of day at which the ozone generator (42) is activated to provide the cold water tank (3) with a defined amount of ozone gas. The invention provides that such time(s) may also be controlled through the user display (11). Referring to FIG. 21, the dispenser will preferably include a seal (55), which is configured to seal a wall between the cold water tank (3) and receptacle (2) (to prevent ozone gas from escaping the cold water tank (3)).

In these embodiments, the receptacle (2) will preferably include an ozone escape tube and connected filter (54B). The escape tube and connected filter (54B) are configured to capture and destroy (or sequester) excess ozone gas (to prevent ozone gas from escaping into ambient air). In such embodiments, the connected filter (54B) may be comprised of activated carbon (either block or granular forms of activated carbon). The invention provides that, in certain alternative embodiments, the ozone escape tube and connected filter (54B) may be positioned within and fluidly coupled to an area above the water level in the cold water tank (3).

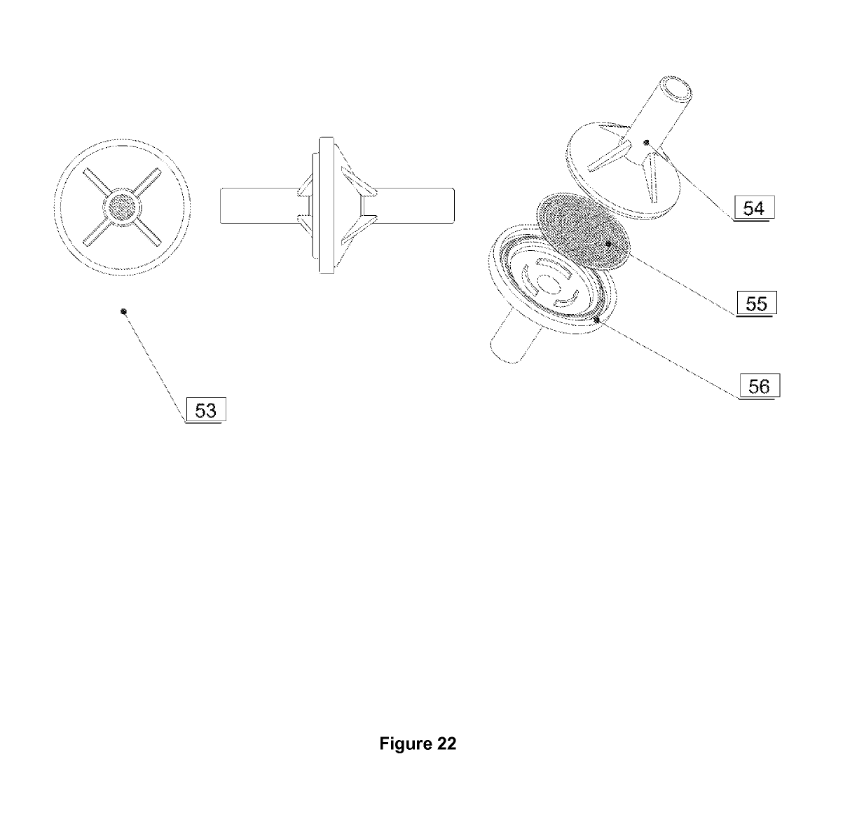

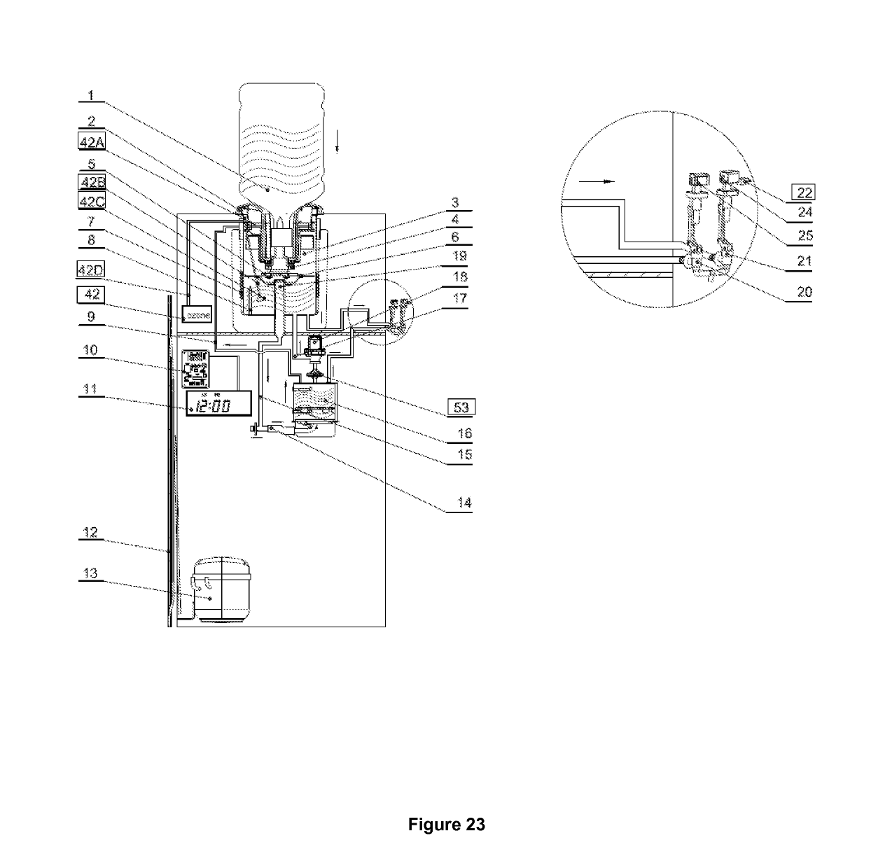

Referring now to FIGS. 22 and 23, in certain embodiments, the water dispensers may further include a filter (53), located between solenoid valve (18) and the hot water tank (16). In the embodiment shown in FIG. 23, the filter (53) is positioned in-line with tube (17). Referring to FIG. 22, the filter (53) will preferably include a top cover (54), a stainless steel filter screen (55), a bottom cover (56), and seal rings to encourage a water-tight fitting. When the dispensers of the present invention are used with mineral water, calcium will accumulate in the hot water tank (16). If grains of calcium enter a water pump (43) or the solenoid valve (18) of the dispenser, it may damage the dispenser or compromise its operation. The invention provides that filter (53) is configured to prevent such calcium from entering a water pump (43) or the solenoid valve (18) of the dispenser.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A top-loading bottled water dispenser, which comprises:
(a) a cabinet that includes a receptacle on a top surface of the cabinet, wherein the receptacle is configured to receive a water bottle in an inverted position, such that the water bottle is fluidly coupled to a cold tank;
(b) a probe that is attached to a floating disk valve, wherein the probe is configured to be inserted into a neck portion of the water bottle and comprises an aperture through which water may flow and enter the cold tank, wherein the floating disk valve (i) is configured to be positioned outside of the neck portion of the water bottle, (ii) is configured to float on a surface of water in the cold tank and to prevent entry of hot water into the water bottle, and (iii) comprises an aperture in a center area of the floating disk valve that is configured to balance air pressure between the water bottle and the cold tank;
(c) an evaporator that is attached to or positioned within the cold tank, which is configured to chill the water contained in the cold tank;
(d) a hot tank that is fluidly coupled to the cold tank through one or more tubes, wherein the hot tank comprises or is attached to a heating element that is configured to heat the water in the hot tank;
(e) a first external faucet that is fluidly coupled to the cold tank and a second external faucet that is fluidly coupled to the hot tank; and
(f) an electronic control board that is configured to cause a volume of water contained in the cold tank to be heated above a defined threshold temperature and for a defined period of time that is effective to sanitize internal surfaces of the cold tank.

2. The top-loading bottled water dispenser of claim 1, wherein the electronic control board is configured to heat the volume of water contained in the cold tank by (a) opening a valve located within a dedicated tube that fluidly couples the cold tank and hot tank and (b) causing hot water to flow from the hot tank and into the cold tank through the dedicated tube.

3. The top-loading bottled water dispenser of claim 1, wherein the electronic control board is configured to heat the volume of water contained in the cold tank by activating a heating element located within the cold tank.

4. The top-loading bottled water dispenser of claim 1, wherein the electronic control board is configured to heat the volume of water contained in the cold tank by activating a circulating pump to force water from the hot tank and into the cold tank through a dedicated tube.

5. The top-loading bottled water dispenser of claim 4, wherein the electronic control board is programmed to heat the volume of water contained in the cold tank to execute a sanitization procedure (i) during a defined period of time of a specified day or set of days or (ii) upon the instruction of a user of the water dispenser.

6. The top-loading bottled water dispenser of claim 5, wherein the first external faucet that is fluidly coupled to the cold tank is prevented from dispensing water during a sanitization procedure.

7. The top-loading bottled water dispenser of claim 6, wherein the first external faucet is operably coupled to a solenoid valve that, when instructed by the electronic control board, is configured to close and prevent the first external faucet from being operated by a user to dispense water from the cold tank during a sanitization procedure.

8. The top-loading bottled water dispenser of claim 7, wherein the electronic control board is programmed to deactivate a compressor that is coupled to the evaporator during a sanitization procedure.

9. The top-loading bottled water dispenser of claim 8, which further comprises an ozone generator that is configured to provide ozone gas to the cold tank via an ozone tube that fluidly couples the ozone generator to the cold tank.

10. The top-loading bottled water dispenser of claim 9, wherein the ozone tube terminates above the surface of water in the cold tank.

11. The top-loading bottled water dispenser of claim 9, wherein the ozone tube terminates below the surface of water in the cold tank.

12. The top-loading bottled water dispenser of claim 11, wherein the ozone tube comprises a diffuser at its terminal end, below the surface of water in the cold tank.

13. The top-loading bottled water dispenser of claim 1, which further comprises a pressure valve located in the cold tank or receptacle.
